(19) United States
(12) Patent Application Publication
(10) Pub. No.: US 2025/0153442 A1
(43) Pub. Date: May 15, 2025

(54) MANUFACTURING METHOD AND SYSTEM FOR AIRBAG

(71) Applicant: ZF Automotive Technologies (Shanghai) Co., Ltd, Shanghai (CN)

(72) Inventor: Songwei ZHOU, Shanghai (CN)

(21) Appl. No.: 18/722,976

(22) PCT Filed: Dec. 23, 2022
(86) PCT No.: PCT/CN2022/141253

§ 371 Date: Jun. 21, 2024

(30) Foreign Application Priority Data
Dec. 24, 2021 (CN) 202111599596.8

(51) Int. Cl. B29C 64/393; B29C 64/209; B29C 64/40; B29K 67/00; B29K 77/00; B29L 22/02; B33Y 10/00; B33Y 30/00; B33Y 50/02; B33Y 70/00; B33Y 80/00

(52) U.S. Cl. CPC B29C 64/393; B29C 64/209; B29C 64/40; B29K 2067/003; B29K 2077/00; B29L 2022/027; B33Y 10/00; B33Y 30/00; B33Y 50/02; B33Y 70/00; B33Y 80/00

(57) ABSTRACT

The present invention provides a method and system for manufacturing an airbag. The manufacturing method includes the following steps: creating a 3D printing model, and providing an inner mold; determining the number of 3D printing nozzles and a positional relationship between each 3D printing nozzle and the inner mold according to the 3D printing model, and assigning a printing task to each 3D printing nozzle; controlling each 3D printing nozzle to execute a respective printing task on an outer surface of the inner mold so as to form a ply on the outer surface of the inner mold; and removing the 3D printing nozzles and the inner mold after all printing tasks are completed, so as to remove the ply from the outer surface of the inner mold. The ply forming the airbag is directly formed by means of 3D printing, thereby avoiding the steps of cutting and sewing in the conventional process, so that the reliability of the airbag is improved and the mass production efficiency is improved.

### TECHNICAL FIELD

The present invention relates to a method and system for manufacturing an airbag.

### BACKGROUND ART

In motor vehicles, airbags have basically become an essential component. At present, most airbags are obtained by a process in which firstly, textile particles are spun into yarns; next, the yarns (warp and weft yarns) are woven and coated with glue to form cloth; then, the cloth is cut into pieces having proper shapes and sizes; and finally, the pieces are sewn to form the airbag.

The existing process includes cutting and sewing steps, and the process quality thereof directly affects the safety factor of the airbag. Moreover, the existing process also involves the use of various apparatuses, which undoubtedly increases the production cost.

### SUMMARY OF THE INVENTION

The present invention provides a method and system for manufacturing an airbag using 3D printing in order to solve the defects that the manufacturing of the airbag in the prior art involves a plurality of procedures such as spinning, weaving, cutting, sewing, etc., various apparatuses need to be purchased, and the production cost is high.

The objective of the present invention is realized by the following technical solutions.

A method for manufacturing an airbag includes the following steps:
S1: creating a 3D printing model, and providing an inner mold;
S2: determining the number of 3D printing nozzles and a positional relationship between each 3D printing nozzle and the inner mold according to the 3D printing model, and assigning a printing task to each 3D printing nozzle;
S3: controlling each 3D printing nozzle to execute a respective printing task on an outer surface of the inner mold so as to form a ply on the outer surface of the inner mold; and
S4: removing the 3D printing nozzles and the inner mold after all printing tasks are completed, so as to remove the ply from the outer surface of the inner mold.

Preferably, the printing task includes at least one of the following information: a printing material, a printing temperature, a discharging rate at each printing position, and a movement trajectory of the 3D printing nozzle.

Preferably, the printing material includes polyethylene terephthalate (PET) and polyamide (PA).

Preferably, the printing temperature is 300-350° C.

Preferably, printing areas of at least two 3D printing nozzles overlap. For example, since areas of the airbag in contact with a gas generator need to have a relatively large strength and thickness, it is necessary to performed multiple printings in these areas.

Preferably, step S1 further includes a step of forming a release agent on the outer surface of the inner mold.

Preferably, the inner mold is made of a water-soluble material, which is, for example, polyvinyl glycol or starch, and in step S4, the inner mold is removed by putting the inner mold covered with the ply into water to dissolve the inner mold.

Preferably, the inner mold is made of a gas bag filled with a gas, and in step S4, the inner mold is removed by exhausting the gas from the gas bag. The gas bag is composed of a bag-shaped body and a coating coated on a surface of the bag-shaped body, wherein the bag-shaped body is made of nylon/polyester and other materials, and the coating on the surface may be a silicone/polytetrafluoroethylene material. The gas bag needs to have heat resistance, and needs to meet a hot rod test at 450 degrees Celsius for more than 0.5 seconds. The gas filled in the gas bag is a nonflammable gas, such as nitrogen.

Preferably, each 3D printing nozzle is linearly movable in at least two directions perpendicular to each other, and a spray direction of each 3D printing nozzle is adjustable.

The present invention further provides a system for manufacturing an airbag, the manufacturing system including:
an inner mold;
a model creating unit configured to create a 3D printing model;
a nozzle setting unit configured to determine the number of 3D printing nozzles and a positional relationship between each 3D printing nozzle and the inner mold according to the 3D printing model, and to assign a printing task to each 3D printing nozzle;
an execution unit configured to control each 3D printing nozzle to execute a respective printing task on an outer surface of the inner mold so as to form a ply on the outer surface of the inner mold, and to remove the 3D printing nozzles after all printing tasks are completed; and
a demolding unit configured to remove the inner mold so as to remove the ply from the outer surface of the inner mold.

Preferably, the printing task includes at least one of the following information: a printing material, a printing temperature, a discharging rate at each printing position, and a movement trajectory of the 3D printing nozzle.

Preferably, the printing material includes PET and PA.

Preferably, the printing temperature is 300-350° C.

Preferably, the ply has a thickness of 0.1-1 mm.

Preferably, printing areas of at least two 3D printing nozzles overlap. These overlapping parts correspond to specific parts of the airbag, such as the positions in contact with a gas generator, that require greater strength and thickness.

Preferably, the manufacturing system further includes a coating unit configured to form a release agent on the outer surface of the inner mold.

Preferably, the inner mold is made of a water-soluble material, and the demolding unit is configured to remove the inner mold by putting the inner mold covered with the ply into water to dissolve the inner mold. The water-soluble material is, for example, polyvinyl glycol or starch.

Preferably, the inner mold is made of a gas bag filled with a gas, and the demolding unit is configured to remove the inner mold by exhausting the gas from the gas bag. The gas bag is composed of a bag-shaped body and a coating coated on a surface of the bag-shaped body, wherein the bag-shaped body is made of nylon/polyester and other materials, and the coating on the surface may be a silicone/polytetrafluoroethylene material. The gas bag needs to have heat resistance, and needs to meet a hot rod test at 450 degrees Celsius for more than 0.5 seconds. The gas filled in the gas bag is a nonflammable gas, such as nitrogen.

Preferably, each 3D printing nozzle is linearly movable in at least two directions perpendicular to each other, and a spray direction of each 3D printing nozzle is adjustable.

The present invention further provides a method for manufacturing an airbag, the manufacturing including the following steps:
S1: creating a 3D printing model, and providing an outer mold provided with an opening and a hollow portion;
S2: determining the number of 3D printing nozzles and a starting position of each 3D printing nozzle in the hollow portion according to the 3D printing model, and assigning a printing task to each 3D printing nozzle;
S3: controlling each 3D printing nozzle to enter the hollow portion through the opening to reach a respective starting position, and to execute a respective printing task on an inner surface of the outer mold from the respective starting position so as to form a ply on the inner surface of the outer mold; and
S4: removing the 3D printing nozzles through the opening after the printing tasks are completed, and removing the ply from the inner surface of the outer mold and taking the ply out through the opening.

Preferably, the printing task includes at least one of the following information: a printing material, a printing temperature, a discharging rate at each printing position, and a movement trajectory of the 3D printing nozzle.

Preferably, the printing material includes PET and PA; and/or
preferably, the printing temperature is 300-350° C.

Preferably, the ply has a thickness of 0.1-1 mm.

Preferably, printing areas of at least two 3D printing nozzles overlap. For example, since areas of the airbag in contact with a gas generator need to have a relatively large strength and thickness, it is necessary to performed multiple printings in these areas.

Preferably, step S1 further includes a step of forming a release agent on the inner surface of the outer mold.

Preferably, each 3D printing nozzle is linearly movable in at least two directions perpendicular to each other, and a spray direction of each 3D printing nozzle is adjustable.

Preferably, in step S4, a final position of each 3D printing nozzle in the hollow portion after the printing task is completed is different from the starting position.

The present invention further provides a system for manufacturing an airbag, the manufacturing system including:
an outer mold provided with an opening and a hollow portion;
a model creating unit configured to create a 3D printing model;
a nozzle setting unit configured to determine the number of 3D printing nozzles and a starting position of each 3D printing nozzle in the hollow portion according to the 3D printing model, and to assign a printing task to each 3D printing nozzle;
an execution unit configured to control each 3D printing nozzle to enter the hollow portion through the opening to reach a respective starting position, to execute a respective printing task on an inner surface of the outer mold from the respective starting position so as to form a ply on the inner surface of the outer mold, and to remove the 3D printing nozzles after all printing tasks are completed; and
a demolding unit configured to remove the ply from the inner surface of the outer mold and to take the ply out through the opening.

Preferably, the printing task includes at least one of the following information: a printing material, a printing temperature, a discharging rate at each printing position, and a movement trajectory of the 3D printing nozzle.

Preferably, the printing material includes PET and PA.

Preferably, the printing temperature is 300-350° C.

Preferably, the ply has a thickness of 0.1-1 mm.

Preferably, printing areas of at least two 3D printing nozzles overlap. These overlapping parts correspond to specific parts of the airbag, such as the positions in contact with a gas generator, that require greater strength and thickness.

Preferably, the manufacturing system further includes a coating unit configured to form a release agent on the inner surface of the outer mold.

Preferably, each 3D printing nozzle is linearly movable in at least two directions perpendicular to each other, and a spray direction of each 3D printing nozzle is adjustable.

Preferably, a final position of each 3D printing nozzle in the hollow portion after the printing task is completed is different from the starting position.

The technical effects obtained by the present invention are as follows.

The ply forming the airbag is directly formed by means of 3D printing, thereby avoiding the steps of cutting and sewing in the conventional process, so that the reliability of the airbag is improved. In addition, the manufacturing process of the airbag is simplified, and the mass production efficiency is improved. Through experiments, physical parameters of a 3D printing PET fabric are shown in Table 1.

TABLE 1

| | | | 3D printing | |
|---|---|---|---|---|
| Property | Unit | Direction | PET Fabric | Test Standard |
| Total weight | g/m² | NA | 70 | ISO3801 |
| Thickness | mm | NA | 0.2 | ISO5084 |
| Tensile Strength | N/5 cm | warp | 355-485 | ISO 13934 - 1 |
| | | weft | 374-464 | ISO 13934 - 1 |
| Elongation | % | warp | 56 | ISO 13934 - 1 |
| | | weft | 47 | ISO 13934 - 1 |
| Flammability | mm/min | warp | 16 | ISO 3795 |
| | | weft | 21 | ISO 3795 |
| Stiffness | N | warp | 60 | ASTM D 4032 |
| Static Air | l/dm²/min | NA | 18 | ISO 9237 |
| Permeability | | | | |
| Tear Strength | N | warp | 15 | ISO 13937 - 2 |
| | | weft | 16 | ISO 13937 - 2 |

### BRIEF DESCRIPTION OF THE DRAWINGS

FIG. 1 is a flowchart of a method for manufacturing an airbag using an inner mold according to an embodiment of the present invention;

FIG. 2 is a schematic diagram of a system for manufacturing an airbag using an inner mold according to an embodiment of the present invention;

FIG. 3 is a flowchart of a method for manufacturing an airbag using an outer mold according to another embodiment of the present invention; and

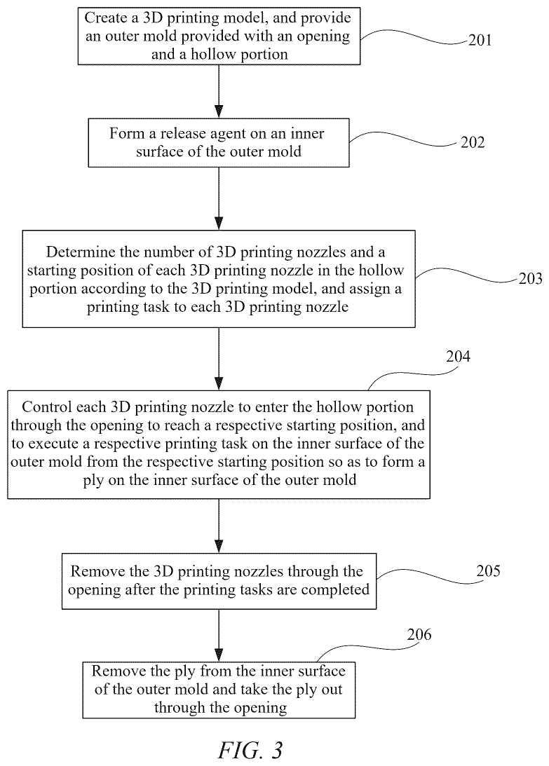

FIG. 4 is a schematic diagram of a system for manufacturing an airbag using an outer mold according to another embodiment of the present invention.

### DETAILED DESCRIPTION OF EMBODIMENTS

The specific implementations of the present invention will be further described below with reference to the accompanying drawings.

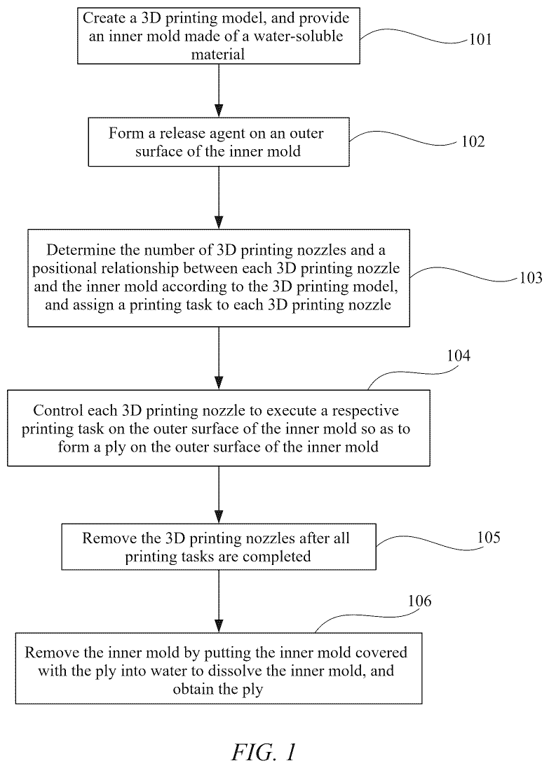

Referring to FIG. 1, a method and system for manufacturing an airbag using an inner mold according to an embodiment of the present invention are introduced. The method for manufacturing an airbag includes the following steps.

In step 101, a 3D printing model is created, and an inner mold made of a water-soluble material is provided. For example, the water-soluble material may be polyvinyl glycol or starch.

In step 102, a release agent is formed on an outer surface of the inner mold to facilitate the subsequent demolding. The release agent is, for example, silicone oil, polyethylene glycol, or the like.

In step 103, the number of 3D printing nozzles and a positional relationship between each 3D printing nozzle and the inner mold are determined according to the 3D printing model, and a printing task is assigned to each 3D printing nozzle. The printing task includes at least one of the following information: a printing material, a printing temperature, a discharging rate at each printing position, and a movement trajectory of the 3D printing nozzle. Each 3D printing nozzle is linearly movable in at least two directions perpendicular to each other, and a spray direction of each 3D printing nozzle is adjustable.

The printing material met the requirement that after 3000 hours of moist heat aging, the residual breaking strength rate is >80% at 100° C. In this embodiment, PET is used, and the printing temperature is 300-350° C.

In order to enhance the strength of a predetermined part, printing areas of two 3D printing nozzles overlap, so that the predetermined part undergoes material printing twice, and the thickness and strength are enhanced.

In step 104, each 3D printing nozzle is controlled to execute a respective printing task on an outer surface of the inner mold so as to form a ply on the outer surface of the inner mold.

In step 105, the 3D printing nozzles are removed after all printing tasks are completed.

In step 106, the inner mold is dissolved by putting the inner mold covered with the ply in water, so as to obtain the ply.

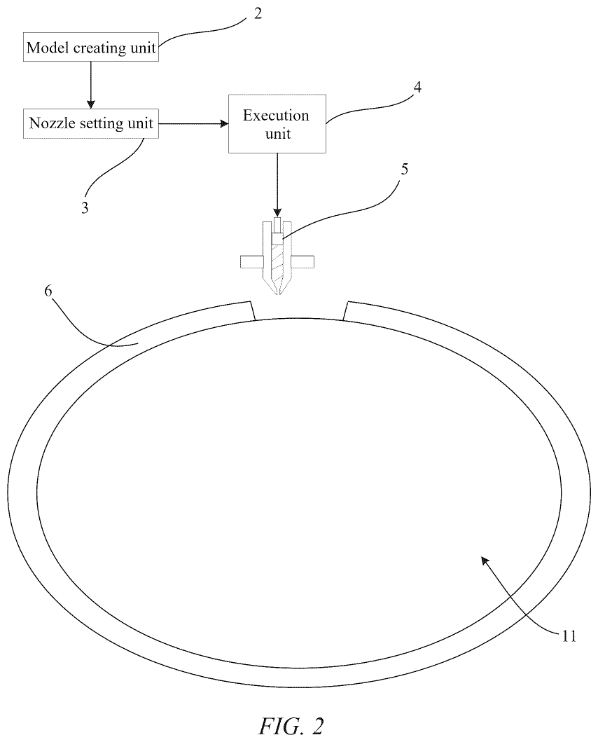

Accordingly, referring to FIG. 2, the system for manufacturing an airbag according to this embodiment includes: an inner mold 11; a model creating unit 2 configured to create a 3D printing model; a nozzle setting unit 3 configured to determine the number of 3D printing nozzles and a positional relationship between each 3D printing nozzle and the inner mold according to the 3D printing model, and to assign a printing task to each 3D printing nozzle; an execution unit 4 configured to control each 3D printing nozzle 5 to execute a respective printing task on an outer surface of the inner mold 11 so as to form a ply 6 on the outer surface of the inner mold, and to remove the 3D printing nozzles after all printing tasks are completed; and a demolding unit configured to remove the inner mold so as to remove the ply from the outer surface of the inner mold.

In another preferred embodiment, a gas bag filled with a gas (e.g., nitrogen) is used as the inner mold, and after the 3D printing nozzles are removed, the inner mold is removed by exhausting the gas from the gas bag so as to obtain the ply.

Referring to FIG. 2, a method and system for manufacturing an airbag using an outer mold according to another embodiment of the present invention are introduced.

The manufacturing method includes the following steps.

In step 201, a 3D printing model is created, and an outer mold provided with an opening and a hollow portion is provided. Metal, such as stainless steel, may be selected as the material of the outer mold.

In step 202, a release agent is formed on an inner surface of the outer mold. For example, a release agent nozzle is used for spraying the release agent evenly on the inner surface of the outer mold, so that the inner surface of the outer mold is coated with the release agent. The release agent may also be coated manually.

In step 203, the number of 3D printing nozzles and a starting position of each 3D printing nozzle in the hollow portion are determined according to the 3D printing model, and a printing task is assigned to each 3D printing nozzle. The printing task includes at least one of the following information: a printing material, a printing temperature, a discharging rate at each printing position, and a movement trajectory of the 3D printing nozzle.

In this embodiment, the printing material is PA. The printing material is heated to 350° C. by the 3D printing nozzle and becomes a high-temperature molten state, then covers the inner surface of the outer mold, and is solidified and becomes a part of a ply after cooling down.

In step 204, each 3D printing nozzle is controlled to enter the hollow portion through the opening to reach a respective starting position, and to execute a respective printing task on the inner surface of the outer mold from the respective starting position so as to form the ply on the inner surface of the outer mold.

Printing areas of at least two 3D printing nozzles overlap. For some predetermined positions, such as the positions connected to the gas generator, in order to strengthen the strength of the airbag, each of the plurality of 3D printing nozzles executes a printing task at these positions, so that the airbag has a greater thickness at these positions after being printed multiple times.

In step 205, the 3D printing nozzles are removed through the opening after the printing tasks are completed. A final position of each 3D printing nozzle in the hollow portion after the printing task is completed is different from the starting position.

In step 206, the ply is removed from the inner surface of the outer mold and taken out through the opening. For example, the ply is removed manually, or automatically by a suction device.

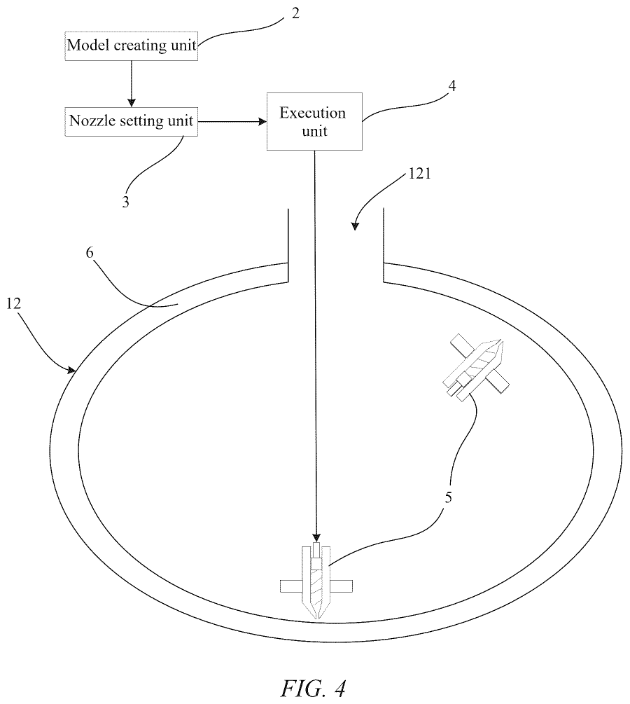

Accordingly, referring to FIG. 4, the system for manufacturing an airbag according to this embodiment includes: an outer mold 12, the outer mold 12 being provided with an opening 121 and a hollow portion; a model creating unit 2 configured to create a 3D printing model; a nozzle setting unit 3 configured to determine the number of 3D printing nozzles and a starting position of each 3D printing nozzle in the hollow portion according to the 3D printing model, and to assign a printing task to each 3D printing nozzle; an execution unit 4 configured to control each 3D printing nozzle 5 to enter the hollow portion through the opening to reach a respective starting position, to execute a respective printing task on an inner surface of the outer mold from the respective starting position so as to form a ply 6 on the inner surface of the outer mold, and to remove the 3D printing nozzles after all printing tasks are completed; and a demolding unit configured to remove the ply from the inner surface of the outer mold and to take the ply out through the opening 121. In FIG. 2, taking an example in which two 3D printing nozzles are provided, a connecting line between the execution unit 4 and one of the 3D printing nozzles indicates a signal relationship therebetween (for the sake of simplicity of illustration, the illustration of the signal relationship between the execution unit and the other 3D printing nozzles is omitted). Specifically, the execution unit may be configured as a manipulator for manipulating the 3D printing nozzles.

The manufacturing system further includes a coating unit configured to form a release agent on the inner surface of the outer mold. The release agent is, for example, silicone oil, polyethylene glycol, or the like. The coating unit, for example, uses a release agent nozzle to spray the release agent evenly on the inner surface of the outer mold, so that the inner surface of the outer mold is coated with the release agent. In other embodiments, the release agent may also be coated manually.

Different from the conventional manufacturing of the airbag by means of weaving and cutting, the airbag is molded once by means of 3D printing, thereby simplifying the manufacturing process and further ensuring the reliability of the airbag with the cutting and sewing steps omitted.

Although the specific embodiments of the present invention are described above, it should be appreciated by those skilled in the art that these are merely illustrative and that the scope of protection of the present invention is defined by the appended claims. Various changes or modifications to these embodiments may be made by those skilled in the art without departing from the principle and spirit of the present invention, and these changes or modifications fall within the scope of the present invention.

1. A method for manufacturing an airbag, the manufacturing method comprising the following steps:
S1: creating a 3D printing model, and providing an inner mold;
S2: determining the number of 3D printing nozzles and a positional relationship between each 3D printing nozzle and the inner mold according to the 3D printing model, and assigning a printing task to each 3D printing nozzle;
S3: controlling each 3D printing nozzle to execute a respective printing task on an outer surface of the inner mold so as to form a ply on the outer surface of the inner mold; and
S4: removing the 3D printing nozzles and the inner mold after all printing tasks are completed, so as to remove the ply from the outer surface of the inner mold.

2. The manufacturing method of claim 1, wherein the printing task comprises at least one of the following information: a printing material, a printing temperature, a discharging rate at each printing position, and a movement trajectory of the 3D printing nozzle.

3. The manufacturing method of claim 2, wherein the printing material comprises PET and PA; and/or
the printing temperature is 300-350° C.

4. The manufacturing method of claim 1, wherein printing areas of at least two 3D printing nozzles overlap.

5. The manufacturing method of claim 1, wherein step S1 further comprises a step of forming a release agent on the outer surface of the inner mold.

6. The manufacturing method of claim 1, wherein the inner mold is made of a water-soluble material, and in step S4, the inner mold is removed by putting the inner mold covered with the ply into water to dissolve the inner mold.

7. The manufacturing method of claim 1, wherein the inner mold is made of a gas bag filled with a gas, and in step S4, the inner mold is removed by exhausting the gas from the gas bag.

8. The manufacturing method of claim 1, wherein each 3D printing nozzle is linearly movable in at least two directions perpendicular to each other, and a spray direction of each 3D printing nozzle is adjustable.

9. A system for manufacturing an airbag, the manufacturing system comprising:
an inner mold;
a model creating unit configured to create a 3D printing model;
a nozzle setting unit configured to determine the number of 3D printing nozzles and a positional relationship between each 3D printing nozzle and the inner mold according to the 3D printing model, and to assign a printing task to each 3D printing nozzle;
an execution unit configured to control each 3D printing nozzle to execute a respective printing task on an outer surface of the inner mold so as to form a ply on the outer surface of the inner mold, and to remove the 3D printing nozzles after all printing tasks are completed; and
a demolding unit configured to remove the inner mold so as to remove the ply from the outer surface of the inner mold.

10. The manufacturing system of claim 9, wherein the printing task comprises at least one of the following information: a printing material, a printing temperature, a discharging rate at each printing position, and a movement trajectory of the 3D printing nozzle.

11. The manufacturing system of claim 10, wherein the printing material comprises PET and PA; and/or
the printing temperature is 300-350° C.; and/or
the ply has a thickness of 0.1-1 mm.

12. The manufacturing system of claim 9, wherein printing areas of at least two 3D printing nozzles overlap.

13. The manufacturing system of claim 9, further comprising a coating unit configured to form a release agent on the outer surface of the inner mold.

14. The manufacturing system of claim 9, wherein the inner mold is made of a water-soluble material, and the demolding unit is configured to remove the inner mold by putting the inner mold covered with the ply into water to dissolve the inner mold.

15. The manufacturing system of claim 9, wherein the inner mold is made of a gas bag filled with a gas, and the demolding unit is configured to remove the inner mold by exhausting the gas from the gas bag.

16. The manufacturing system of claim 9, wherein each 3D printing nozzle is linearly movable in at least two directions perpendicular to each other, and a spray direction of each 3D printing nozzle is adjustable.

17. A method for manufacturing an airbag, the manufacturing method comprising the following steps:
S1: creating a 3D printing model, and providing an outer mold provided with an opening and a hollow portion;
S2: determining the number of 3D printing nozzles and a starting position of each 3D printing nozzle in the hollow portion according to the 3D printing model, and assigning a printing task to each 3D printing nozzle;
S3: controlling each 3D printing nozzle to enter the hollow portion through the opening to reach a respective starting position, and to execute a respective printing task on an inner surface of the outer mold from the respective starting position so as to form a ply on the inner surface of the outer mold; and
S4: removing the 3D printing nozzles through the opening after the printing tasks are completed, and removing the ply from the inner surface of the outer mold and taking the ply out through the opening.

18. The manufacturing method of claim 17, wherein the printing task comprises at least one of the following information: a printing material, a printing temperature, a discharging rate at each printing position, and a movement trajectory of the 3D printing nozzle.

19. The manufacturing method of claim 18, wherein the printing material comprises PET and PA; and/or
the printing temperature is 300-350° C.; and/or
the ply has a thickness of 0.1-1 mm.

20. The manufacturing method of claim 17, wherein printing areas of at least two 3D printing nozzles overlap.

21. The manufacturing method of claim 17, wherein step S1 further comprises a step of forming a release agent on the inner surface of the outer mold.

22. The manufacturing method of claim 17, wherein each 3D printing nozzle is linearly movable in at least two directions perpendicular to each other, and a spray direction of each 3D printing nozzle is adjustable.

23. The manufacturing method of claim 17, wherein in step S4, a final position of each 3D printing nozzle in the hollow portion after the printing task is completed is different from the starting position.

24. A system for manufacturing an airbag, the manufacturing system comprising:
an outer mold provided with an opening and a hollow portion;
a model creating unit configured to create a 3D printing model;
a nozzle setting unit configured to determine the number of 3D printing nozzles and a starting position of each 3D printing nozzle in the hollow portion according to the 3D printing model, and to assign a printing task to each 3D printing nozzle;
an execution unit configured to control each 3D printing nozzle to enter the hollow portion through the opening to reach a respective starting position, to execute a respective printing task on an inner surface of the outer mold from the respective starting position so as to form a ply on the inner surface of the outer mold, and to remove the 3D printing nozzles after all printing tasks are completed; and
a demolding unit configured to remove the ply from the inner surface of the outer mold and to take the ply out through the opening.

25. The manufacturing system of claim 24, wherein the printing task comprises at least one of the following information: a printing material, a printing temperature, a discharging rate at each printing position, and a movement trajectory of the 3D printing nozzle.

26. The manufacturing system of claim 25, wherein the printing material comprises PET and PA; and/or
the printing temperature is 300-350° C.; and/or
the ply has a thickness of 0.1-1 mm.

27. The manufacturing system of claim 24, wherein printing areas of at least two 3D printing nozzles overlap.

28. The manufacturing system of claim 24, further comprising a coating unit configured to form a release agent on the inner surface of the outer mold.

29. The manufacturing system of claim 24, wherein each 3D printing nozzle is linearly movable in at least two directions perpendicular to each other, and a spray direction of each 3D printing nozzle is adjustable.

30. The manufacturing system of claim 24, wherein a final position of each 3D printing nozzle in the hollow portion after the printing task is completed is different from the starting position.
